(19) United States
(12) Patent Application Publication
(10) Pub. No.: US 2026/0069507 A1
(43) Pub. Date: Mar. 12, 2026

(54) BABY BOTTLE

(71) Applicants: Breannan Marrder, Sandy, UT (US); Obed Marrder, Sandy, UT (US)

(72) Inventors: Breannan Marrder, Sandy, UT (US); Obed Marrder, Sandy, UT (US)

(21) Appl. No.: 18/827,673

(22) Filed: Sep. 7, 2024

(51) Int. Cl. A61J 9/00; A61J 11/00

(52) U.S. Cl. CPC A61J 9/001; A61J 11/008; A61J 11/0015

(57) ABSTRACT

An improved baby bottle having an exterior shell (or sleeve) housing a flexible bladder. The improved baby bottle comprises a collar and a hood affixable over the collar. In some embodiments, the hood comprises one or more laterally-protruding tabs. In other embodiments, the exterior shell defines an open bottom end and/or is metered. The nipple of the bottle comprises a slit shaped to form cusps which pull away from the nipple when sucked.

### BACKGROUND OF THE INVENTION

### Field of the Invention

This invention relates to a drinking implement, and more particularly relates to a baby bottle with improved dispensing means.

### Description of the Related Art

Baby bottles have been well-known in the art for decades. Baby bottles are used for the artificial nursing of infant children in various forms, shapes, and configurations. Newborn babies and infants being transitioned from nursing to bottles can sometimes resist taking or drinking milk or formula from conventional baby bottles, or resist the process of trying to transition from nursing to bottles. The process of seeing babies through this process can become tiresome for parents.

Traditional baby bottles are cylindrically shaped with vertically-rising nipples. Traditional baby bottles are overly elongated and have to be lifted to an excessive height for a baby to drink from them, such that the bottom of the bottle is higher than the nipple because of the fact that traditional bottles rely on gravity for the dispensing process. Because traditional baby bottles rely on gravity, they have a passive flow. Whether or not the baby is sucking, the fluid from the bottle is dripping into the baby's mouth. The only way to control the flow rate of a traditional baby bottle is by increasing or decreasing the number or size of pinholes through which ambient air travels into the bottle.

Cradling and feeding a baby can become tiresome for parents. Babies traditionally feed from a bottle on their back such that the bottle is elevated and gravity acts to pull fluid downward. There is a need in the art for a baby bottle which effectively feeds a baby in any feeding position and which dispenses milk or fluid when the bottle is actively engaged by an infant in any feeding position rather than only when the milk or fluid is passively dripped from the bottle.

In traditional baby bottles, negative pressure builds in the bottle as milk is dispensed. This negative pressure initially causes the baby to have to suck harder for the milk to be dispensed and finally prevents milk from being dispensed. This problem has traditionally been resolved by using valves on the nipple and/or container body which allow ambient air to traverse into the void created in the fluid container of the bottle. Additionally, traditional baby bottles force a baby to use its tongue as a piston to stop or slow the flow of milk and do not promote the development of the same oral reflexes and muscle memory as nursing.

Traditional baby bottles in the art allow the inflow of ambient air through valves or pinholes in the bottles to fill the vacuum left in the bottle by fluid being dispensed. This trapped stagnant air within the bottle can present an inconvenience, and potential health hazard for children, in the contributing to colic, gas, GERD, and vomiting in children who ingest it.

It is an object of the present invention to provide a baby bottle which overcomes these difficulties. These and other objects and advantages of the present invention are desirable in the art.

### SUMMARY OF THE INVENTION

From the foregoing discussion, it should be apparent that a need exists for an improved baby bottle. Beneficially, such an apparatus would overcome many of the difficulties and safety concerns expressed. The present invention has been developed in response to the problems and needs in the art that have not yet been fully solved by currently available apparati and methods. Accordingly, the present invention has been developed to provide a baby bottle comprising: an exterior cylindrical sleeve defining a hollow interior recess and an open bottom end; wherein the exterior cylindrical sleeve affixes to a threaded stem rising superiorly; a flexible, transparent bladder housed within the exterior cylindrical recess; a nipple forming a friction fit with the bladder, the nipple comprising an areola and a teat; wherein a top surface of the nipple defines a circular recess having a lower valve surface into which is cut a slit shaped as one of: a X, a Y, or an irregular shaped with chiral bent arms forming rotationally around a centric point; an annular collar interiorly threaded and operable to screw onto the stem; and a hood detachably affixable to one of the collar and exterior sleeve, the hood forming a convex cap.

The slit may define a plurality of cusps which pull away from the teat when negative sucking pressure of an infant is applied. The exterior sleeve may be metered.

The exterior sleeve may define a transparent window through which the bladder is viewable. The hood may further comprise one or more tabs jutting laterally outward.

These features and advantages of the present invention will become more fully apparent from the following description and appended claims, or may be learned by the practice of the invention as set forth hereinafter

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an elevational frontal-side perspective view of an improved baby bottle in accordance with the present invention;

FIG. 2A is an exploded, top perspective view of an improved baby bottle in accordance with the present invention;

FIG. 2B is an exploded, top perspective view of an improved baby bottle in accordance with the present invention;

FIG. 3A is an exploded, side perspective view of an improved baby bottle in accordance with the present invention;

FIG. 3B is an exploded, side perspective view of an improved baby bottle in accordance with the present invention;

FIG. 3C is an exploded, side perspective view of an improved baby bottle in accordance with the present invention;

FIG. 4A is an exploded, bottom perspective view of an improved baby bottle in accordance with the present invention;

FIG. 4B is an exploded, bottom perspective view of an improved baby bottle in accordance with the present invention;

FIG. 5 is an isometric perspective view of a nipple of an improved baby bottle in accordance with the present invention;

FIG. 6A is a top perspective view of a nipple of an improved baby bottle in accordance with the present invention;

FIG. 6B is a sectioned side perspective view of a nipple of an improved baby bottle in accordance with the present invention;

FIG. 7 is a side perspective view of a bladder of an improved baby bottle in accordance with the present invention; and

FIG. 8 is an environmental, side perspective view of a bladder of an improved baby bottle in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is an object of the present invention to provide a baby bottle which: (1) does not rely on gravity for fluid dispension means; (2) which is airless in the air does not fill the fluid receptacle when fluid is dispensed and which impart an ability to the user to expel the air before use and to express or expel all of the milk or fluid out of the bottle; (3) which is multidirectional in that the bottle may just as easily be used in any vertical or horizontal orientation as any other; and (4) which is baby-led in that the baby controls the feed, including the flow rate.

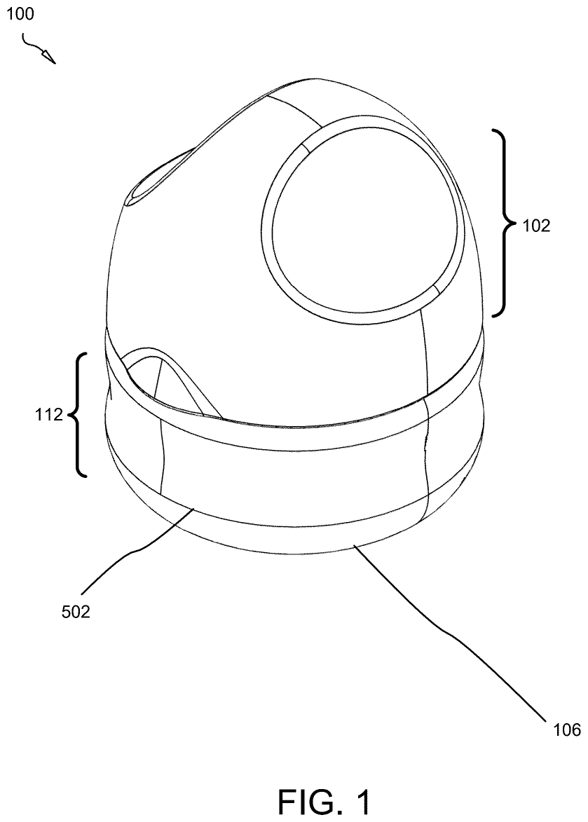

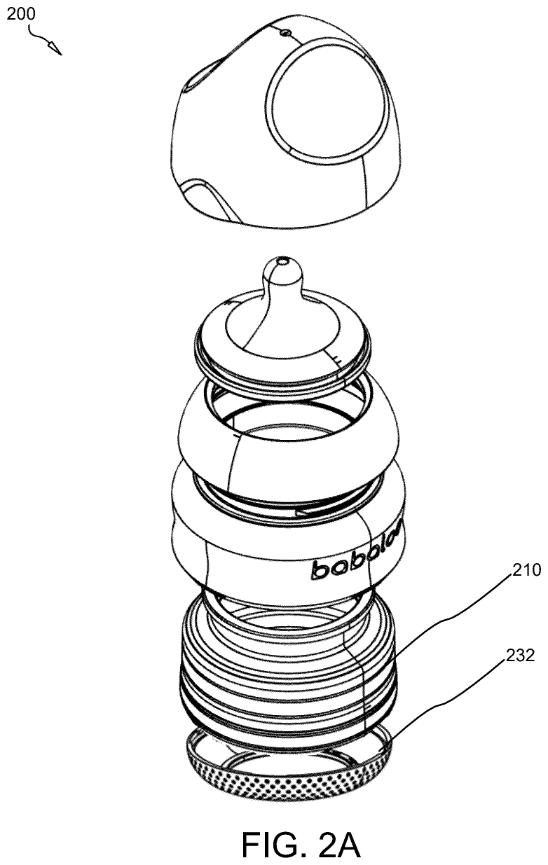

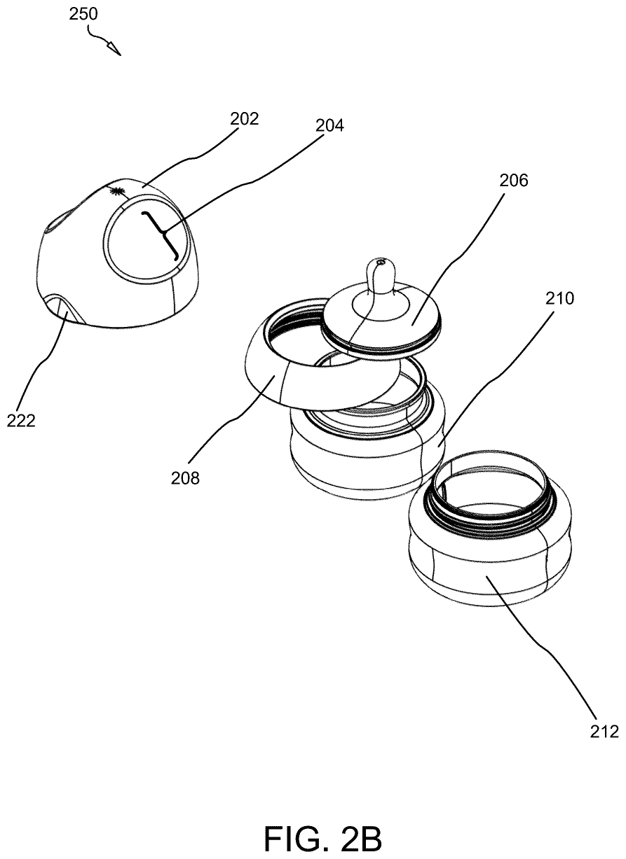

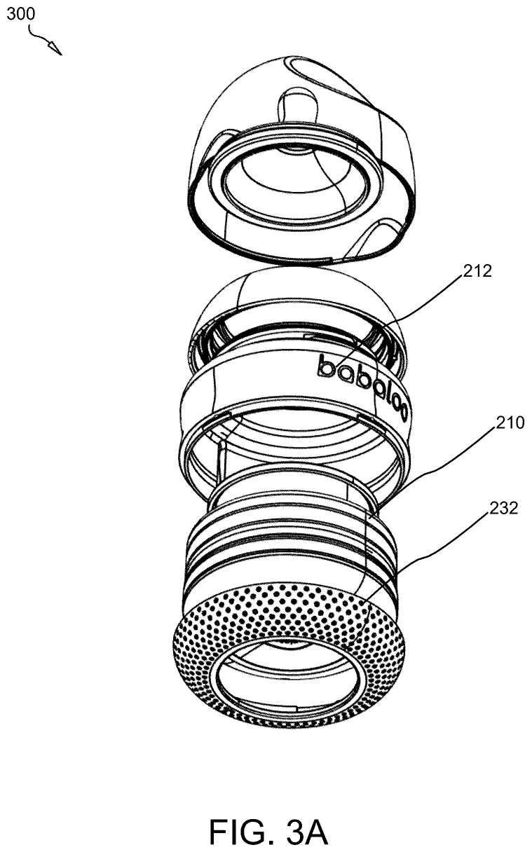

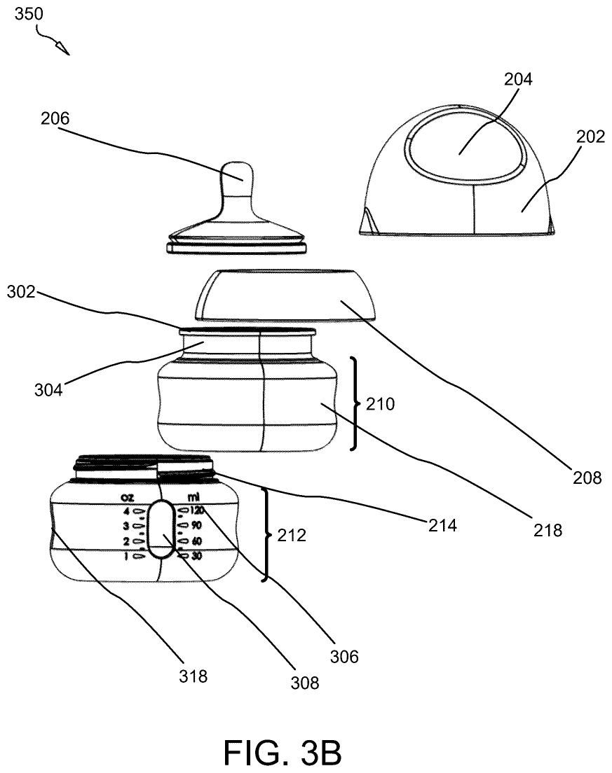

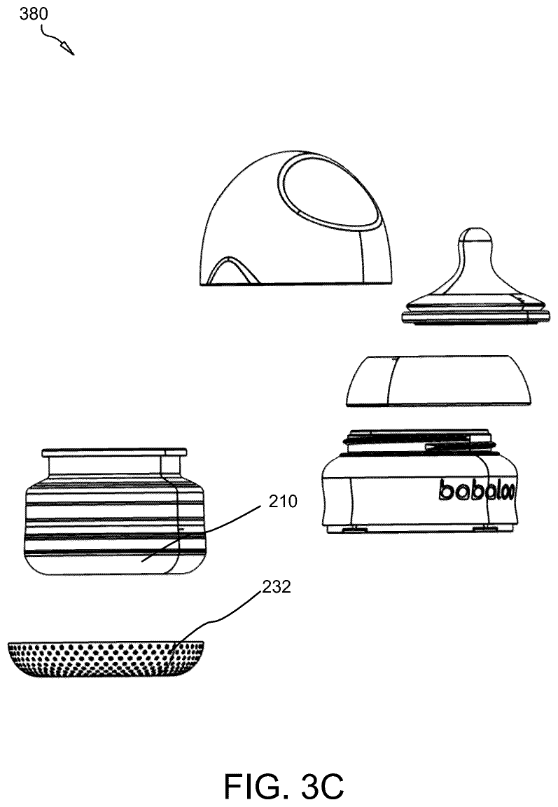

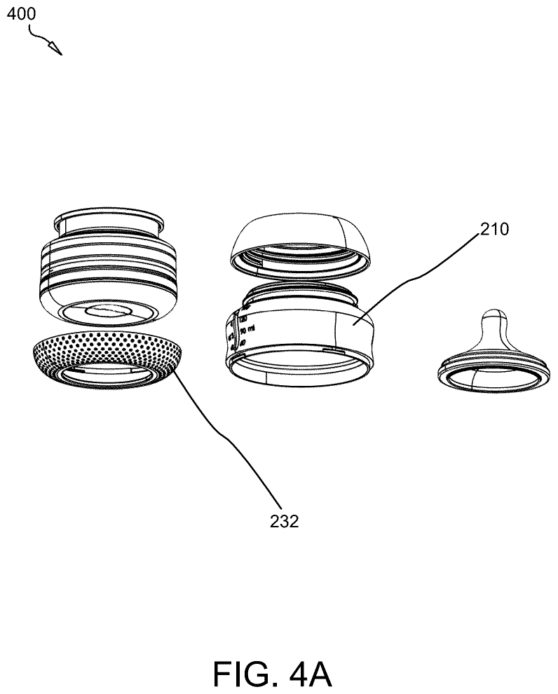

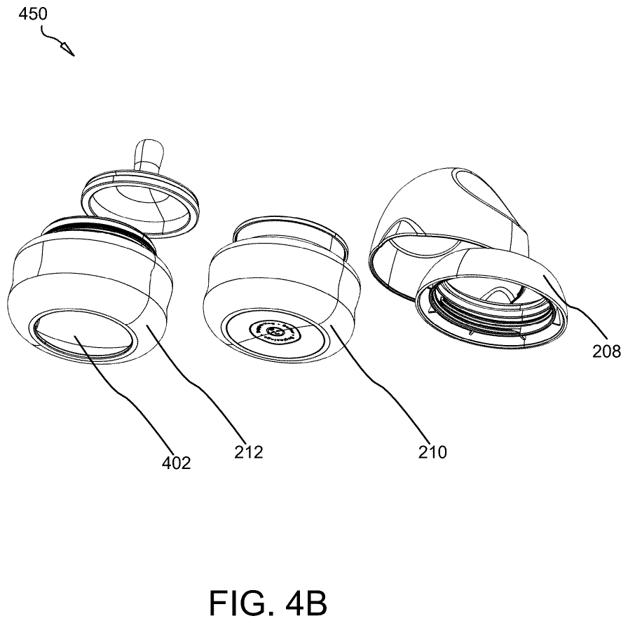

FIGS. 1-4 illustrate perspective views of an improved baby bottle in accordance with the present invention.

The bottle 100 comprises a body 112 (i.e., vessel) which may be cylindrical or which may define an ergonomic, concave recess (i.e., indentation) circumscribing the body 112. The body 112 defines a hollow interior recess.

In various embodiments, a threaded stem 214 rises superiorly from a cylindrical receptacle 210 (i.e., bladder in some embodiments), which is more narrow in diameter than the exterior sleeve 212.

The exterior sleeve 212 may be metered and bear marking 306 indicating a volume within the cylindrical receptacle 210 or a mass within the cylindrical receptacle 210. The exterior sleeve 212 may define a recess 308, or transparent window, through which a fluid level in the cylindrical receptacle 210 may be viewed.

The exterior sleeve may define an open bottom end 402 through which the bladder 210 may be viewed or manipulated tactilely. This manipulation may allow a user, such as an infant or parent, to manually collapse the bladder 208.

The exterior sleeve 212 may comprise a textured annular base 232 which detachably affixed to the exterior sleeve using means known to those of skill in the art, including threading, a snap fit, or friction fit. In some embodiments, the exterior sleeve 212 is formed with the annular base 232 as a single, integrated piece.

The textured annular base 232 may comprise a plurality of protuberances (e.g., bumps) or recesses 234 which may be spaced at regular or irregular intervals across the exterior surface of the textured annular base 232.

The apparatus 200 may additionally or alternatively comprise an exterior sleeve 212. The cylindrical receptacle 210 may be housed within the exterior sleeve 212.

In various embodiments, the cylindrical receptacle 210 may comprise a flexible transparent or translucent bladder into which fluid, such as milk, water or juice is housed. As a flexible bladder 210, the cylindrical receptacle 210 may collapse as fluid is dispensed, reducing negative pressure within the cylindrical receptacle 210 which would otherwise inhibit fluid being dispensed from the nipple to an infant.

Because the bladder 210 is collapsible, the bottle 200 is airless. The nipple uses compression to help promote the development of oral muscles and reflexes which mimic those developed in traditional nursing.

The bladder 210 may be formed from a thin, polymeric material, silicone or silastic material which is fully collapsible. Examples of the materials used to form the bladder 210 may include polyurethane and polyethylene. Because the bladder 210 collapses as milk is dispensed, there is no void or vacuum created within the bladder 210 which must be filled with air to reduce negative pressure on the milk in the bladder 210.

The apparatus 100-400 may comprise a frustoconical collar 208 having interior threading. The frustoconical collar 208 may screw onto the stem 214 of the exterior sleeve 212. The frustoconical collar 208 comprises an annular flange defining a circular interior recess and open top end.

In various embodiments, a nipple 206 inserts into the circular interior recess of the collar 208 and traverses the open top end protruding through the open top end and rising superiorly above the body 112. The nipple 206 may abut, or form a friction fit, with the rim of the stem 214. The friction fit may be watertight such that the fluid within the bladder 210 does not seep or spill from the bladder 208. The nipple 206 may be held in place by the collar 208 screwed down over it.

In various embodiments, the apparatus 100-400 comprises a hood 102. The hood 102 snaps down over the collar 208 and nipple 206. The hood 102 comprises a convex cap operable to form a friction fit with the collar 208 and/or one or more other components of the bottle 100-400.

The hood 102 may comprise one or more tabs 222 which protrude laterally from the hood 102, operable to facilitate removal of the hood 102. In some embodiments, the hood 102 defines indented regions 204 which reduce the overall volume of the apparatus 100-400. These indented regions 204 may allow the hood 102 to be pinched, or grabbed, by a user. In alternative embodiments, the hood 102 defines ovoid apertures 204 through which the nipple 206, or an angular nipple which does not rise directly vertically may be accessed by an infant making use of the bottle.

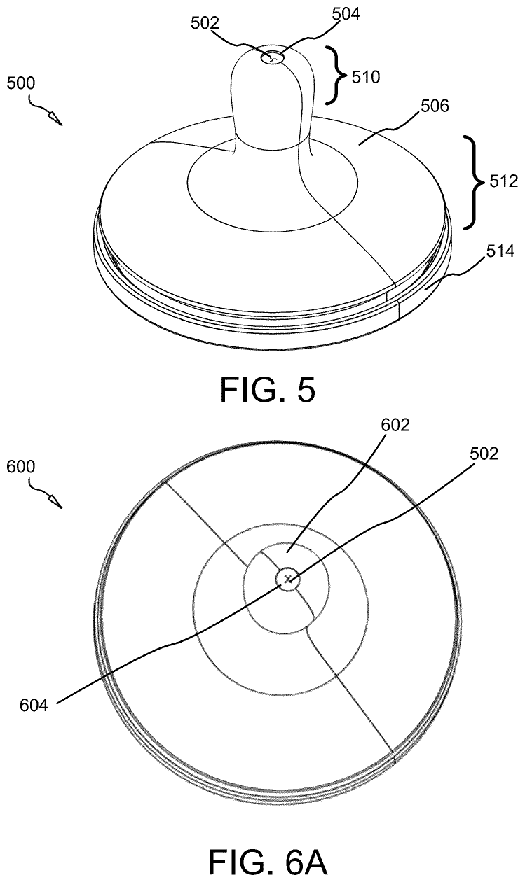

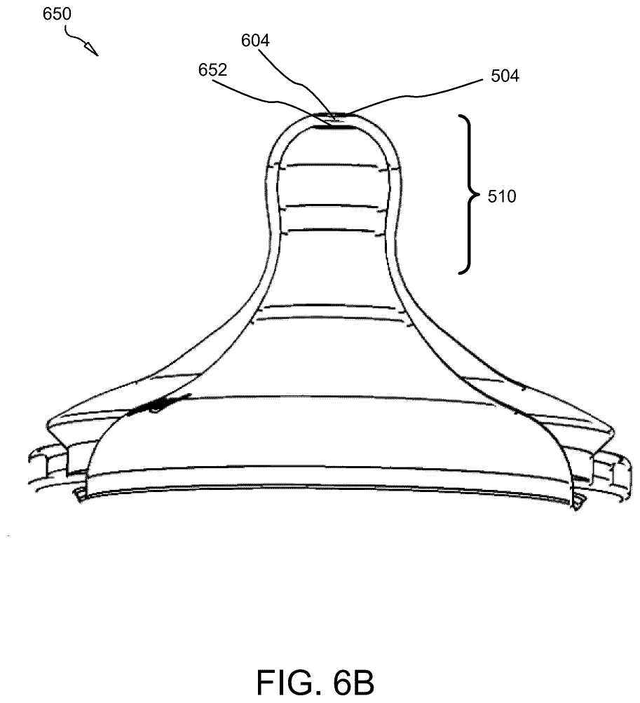

FIGS. 5-6 illustrate perspective views of a nipple 500, 600 of an improved baby bottle in accordance with the present invention.

The nipple 500 comprises an annular flange 514 adapted to abut the bladder or other components of the bottle 100-400. The nipple 500 comprises an areola 512 and a teat 510 which positions centrically on the areola and protrudes superiorly therefrom.

A convex top surface 602 of the teat 510 defines a circular recess 504 having a lower valve surface 604 into which an aperture or slit 502 is cut. The slit may be X-shaped, Y-shaped, or shaped with chiral bent arms formed rotationally around a centric point.

The cusps (i.e., leaflets) formed by the X-shaped slit 502 cut into the lower valve surface 604 are flexed away from the teat 510 when an infant sucks on the nipple 500. The slit 502 operates in place of a pinhole.

The top surface 602, the circular recess 504, the lower valve surface and the slit 502 together comprise a resilient variable flow valve.

The nipple 500 mimics a natural nipple of a mother in that milk, or other fluid housed within a bottle 100, is only dispensed when negative sucking pressure is applied by the infant to the nipple 500. When the infant rolls its tongue across the surface of the nipple 500, 600, outflow of milk may be accelerated or otherwise controlled by the infant.

In various embodiments, the silicone or silastic material 652 forming the lower valve surface 604 is thicker than the silicone or silastic materials used to form the remaining arcuate sidewalls of the teat 510 to impart increased strength to the valve. In some embodiments, the lower valve surface is 0.4 to 1.0 mm thicker than the remaining sidewalls of the teat 510.

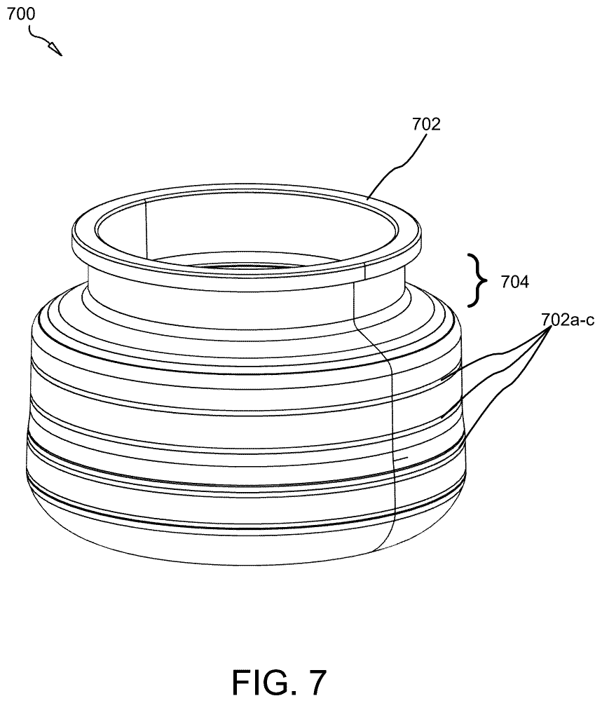

FIG. 7 is a side perspective view of a bladder 700 of an improved baby bottle in accordance with the present invention.

The bladder 700 comprises a flange 702 circumscribing a top edge of the bladder 700, which flange 702 may form a snap fit with other components of the bottle 200.

In various embodiments, the bladder 700 may be, but is not necessarily, ribbed and may comprise ribs. This bladder 210 may comprise textured circumscribing bands 702a-c spaced apart from one another such that the bladder 700 may collapse when fluid housed therein is dispensed. The bands may be formed from texturing the surface of the bladder 700, changing the translucence of the bladder 700 in the banded areas, adding dye to the bands 702, or via other means known to those of skill in the art.

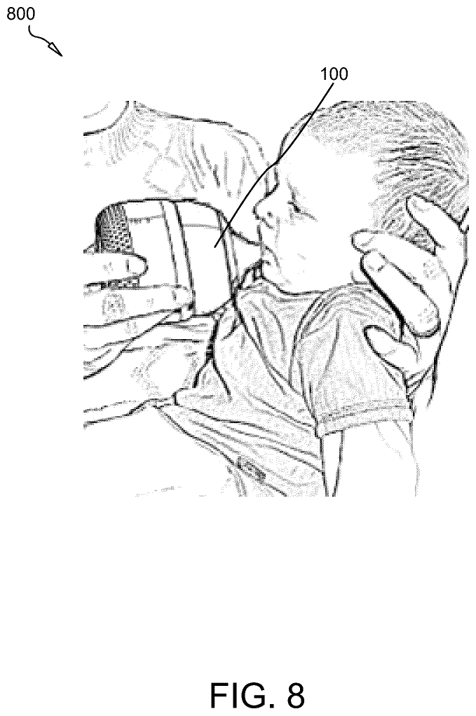

FIG. 8 is an environmental, side perspective view of a bladder of an improved baby bottle in accordance with the present invention.

As shown, bottle 100 may be used from any position in which the baby is resting or moving, including any horizontal or vertical orientation.

The present invention may be embodied in other specific forms without departing from its spirit or essential characteristics. The described embodiments are to be considered in all respects only as illustrative and not restrictive. The scope of the inventio is, therefore, indicated by the appended claims rather than by the foregoing description. All changes which come within the meaning and range of equivalency of the claims are to be embraced within their scope.

What is claimed is:

1. A baby bottle comprising:
an exterior cylindrical sleeve defining a hollow interior recess and an open bottom end;
wherein the exterior cylindrical sleeve affixes to a threaded stem rising superiorly;
a collapsible, transparent bladder housed within the exterior cylindrical recess;
a nipple forming a friction fit with the bladder, the nipple comprising an areola and a teat; wherein a top surface of the nipple defines a circular recess having a lower valve surface into which is cut a slit shaped as one of: a X, a Y, or an irregular shaped with chiral bent arms forming rotationally around a centric point; and
an annular collar interiorly threaded and operable to screw onto the stem.

2. The baby bottle of claim 1, further comprising a hood detachably affixable to one of the collar and exterior sleeve, the hood forming a convex cap.

3. The baby bottle of claim 1, wherein the slit defines a plurality of cusps which pull away from the teat when negative sucking pressure of an infant is applied.

4. The baby bottle of claim 1, wherein the exterior sleeve is metered.

5. The baby bottle of claim 1, wherein the exterior sleeve defines a transparent window through which the bladder is viewable.

6. The baby bottle of claim 1, wherein the lower valve surface of the teat into which the slit is cut is formed of thicker silicone material than remaining sidewalls of the teat.

7. A baby bottle comprising:
an exterior cylindrical sleeve defining a hollow interior recess;
wherein the exterior cylindrical sleeve affixes to a stem rising superiorly;
a flexible, transparent bladder housed within the exterior cylindrical recess operable to collapse in response to negative sucking pressure of an infant;
a nipple forming a friction fit with the bladder, the nipple comprising an areola and a teat into which is cut a slit shaped as one of: a X, a Y, or an irregular shaped with chiral bent arms forming rotationally around a centric point;
wherein the slit defines a plurality of cusps which pull away from the teat when negative sucking pressure of an infant is applied; and
an annular collar interiorly threaded and operable to screw onto the stem.

8. The baby bottle of claim 8, wherein the flexible, transparent bladder comprises silicone.

9. The baby bottle of claim 8, wherein the slit defines a plurality of cusps.

10. A baby bottle comprising:
an exterior cylindrical sleeve defining a hollow interior recess and an open bottom end;
wherein the exterior cylindrical sleeve affixes to a threaded stem rising superiorly;
a flexible, collapsible transparent bladder housed within the exterior cylindrical recess operable to collapse without inletting ambient air when a baby feeds;
a silicone nipple, the nipple comprising an areola and a teat, wherein the nipple defines an aperture and cusps operable to dispense fluid when negative pressure is applied to the cusps; and
an annular collar interiorly threaded and operable to screw onto the stem.

11. The baby bottle of claim 10, wherein the slit defines a plurality of cusps.

12. The baby bottle of claim 10, further comprising a hood detachably affixable to one of the collar and exterior sleeve, the hood forming a convex cap.
